(19) United States
(12) Patent Application Publication
(10) Pub. No.: US 2009/0073814 A1
(43) Pub. Date: Mar. 19, 2009

(54) Low-Displacement Pendulum

(76) Inventor: W. Daniel Hillis, Encino, CA (US)

Correspondence Address: GLENN PATENT GROUP, 3475 EDISON WAY, SUITE L, MENLO PARK, CA, 94025, US

(21) Appl. No.: 12/274,240

(22) Filed: Nov. 19, 2008

Related U.S. Application Data
(62) Division of application No. 11/734,751, filed on Apr. 12, 2007.
(60) Provisional application No. 60/744,722, filed on Apr. 12, 2006.

(51) Int. Cl. G04B 17/02

(52) U.S. Cl. 368/179

(57) ABSTRACT

A gravity pendulum, referred to as a low-displacement pendulum because it does not displace air as it rotates, is disclosed. The low-displacement pendulum uses an unbalanced wheel instead of the more conventional suspended bob. Because the pendulum does not displace air as it rotates, it eliminates an important component of air drag that causes energy loss in a normal pendulum. The low-displacement pendulum also eliminates errors caused by variations in barometric pressure. In addition, it can be easily thermally compensated without the use of special materials, such as Invar.

### CROSS REFERENCE TO RELATED APPLICATION

This application is a DIVISIONAL application of U.S. patent application Ser. No. 11/734,751, filed Apr. 12, 2007, and which claims benefit to U.S. Provisional Application No. 60/744,722, filed on Apr. 12, 2006, which are incorporated herein in their entirety by this reference hereto.

### BACKGROUND OF THE INVENTION

1. Technical Field

The invention relates to time keeping devices. More particularly, the invention relates to a low-displacement pendulum for a mechanical clock.

2. Description of the Prior Art

Historically, the gravity pendulum has been the most successful device for accurately regulating the timing of a mechanical clock. The frequency of such a simple pendulum is approximately proportional to the square root of the ratio of earth's gravity to length of the pendulum (f=2π\sqrt{l/g}). Because the force of gravity is reasonably constant, keeping the period constant is largely a matter of keeping the length constant, which can be accomplished by careful selection of the materials and geometry, paying special attention to expansion due to changes in temperature.

Another potential accuracy problem of a gravity pendulum is that the period of the swing actually depends slightly on the amplitude. The frequency formula mentioned above is based on the assumption that the restoring force created by gravity is proportional to the angle of the bob from vertical, which is only an approximation. Actually, the restoring force is proportional to the sine of that angle. This difference is small as long as the angle is small, but to hold the frequency constant, the average amplitude of the swing must also be held constant.

Friction creates most of the difficulties in holding constant amplitude. The greatest source of friction is often the pendulum motion through the air, but there is also friction in unlocking the escapement and in the suspension. Each of these sources of friction is variable. Also, the existence of any type of friction means that energy must be put back into the pendulum to keep it going. This impulsion of the pendulum can be a major source of variability because it is difficult to deliver the exact same impulse on each tick.

A third source of the error in a pendulum is the variation of the density of air, which changes the buoyancy of the bob. Because some of the weight of the bob is supported by floating in the surrounding air, the restoring force of gravity varies with the density. Because the density of the air depends on the barometric pressure, variations in pressure contribute to variability in the rate of the pendulum.

Eliminating the air around the pendulum can reduce several sources of variability because the air is not only the source of the variable density problem, but it is also the source of much of the friction. For this reason the most accurate clock pendulums are operated in a partial vacuum. It would be advantageous to provide a pendulum has some of the same advantages, but without the complexities of maintaining a partial vacuum.

### SUMMARY OF THE INVENTION

The invention provides a new form of gravity pendulum, which is referred to as a low-displacement pendulum because it does not displace air as it rotates. The low-displacement pendulum uses an unbalanced wheel instead of the more conventional suspended bob. Because the pendulum does not displace air as it rotates, it eliminates an important component of air drag that causes energy loss in a normal pendulum. The low-displacement also eliminates errors caused by variations in barometric pressure. In addition, it can be easily thermally compensated without the use of special materials, such as Invar.

### BRIEF DESCRIPTION OF THE DRAWINGS

FIG. 1 is a side view showing a spoke up configuration of a low displacement pendulum having a knife edge bearing, where a portion of the pendulum ring is made of a higher density material, according to the invention;

FIG. 2 is a side view showing a spoke up configuration of a low displacement pendulum having a suspension spring, where voids are formed in the pendulum ring to create imbalance, according to present invention;

FIG. 3 is a side view showing a spoke up configuration of a low displacement pendulum having upward compensation, where a portion of the pendulum spoke is made of a lower expansion material, and where an optional false spoke is provided to preserve symmetry, according to the invention;

FIG. 4 is a side view showing a spoke down configuration of a low displacement pendulum having a suspension spring, where a pendulum spoke provides weight to create pendulum imbalance, according to the invention;

FIG. 5 is a side view showing a symmetrical spoke configuration of a low displacement pendulum having a knife edge bearing, where a lower portion of the pendulum ring is thinner to create imbalance, according to present invention; and

FIG. 6 is a side view showing a curved spoke configuration of a low displacement pendulum having downward compensation according to the invention.

### DETAILED DESCRIPTION OF THE INVENTION

The invention provides a new form of gravity pendulum, which is referred to as a low-displacement pendulum because it does not displace air as it rotates. The low-displacement pendulum uses an unbalanced wheel instead of the more conventional suspended bob. Because the pendulum does not displace air as it rotates, it eliminates an important component of air drag that causes energy loss in a normal pendulum. The low-displacement also eliminates errors caused by variations in barometric pressure. In addition, it can be easily thermally compensated without the use of special materials, such as Invar.

A key aspect of a low-displacement pendulum is the use of an unbalanced wheel instead of a suspended bob. The unbalance can be accomplished by increasing the amount or density of material in the lower part of the wheel or by decreasing density in the upper part of the wheel. Because a wheel is symmetric about its center of rotation it does not displace air as it rotates. This eliminates a major component of aerodynamic drag, referred to as form drag, leaving only the skin drag caused by sheer in the boundary layer. The lack of displacement also eliminates rotational forces that are caused by buoyancy and which vary with barometric pressure.

The wheel of a low-displacement pendulum may be a full disk, but the inertia per weight can be increased by thinning the center of the pendulum, putting most of the mass in a thin ring around the edge. The mass farther from the center contributes most to the inertia of the wheel. Thus, this lightens the mass required to achieve a given inertia. The skin drag can be reduced by replacing the center hub with one or more spokes between the ring and the center support suspension. If these spokes are placed symmetrically across from each other, the low-displacement property of the pendulum is preserved. In any case, the displacement of the spoke or spokes is small.

The use of spokes creates some additional air drag. This can be minimized by streamlining the shape of the spoke by keeping the cross-section small, and by keeping the number of spokes to a minimum. If a single spoke is used, it can either be above the center, in compression, or below the center, in tension. Which configuration is best depends upon specific details, such as the choice of materials and type of suspension. Materials, such as glass and ceramics, are often much stronger in compression, favoring the spoke-up configuration. Flexible materials, such as metal, may tend to buckle, favoring the spoke-down configuration. The spoke-down configuration is also particularly simple because it uses a flexure bearing, whereas a spoke-up configuration is very simple because it uses a knife-edge suspension.

### A Slower Swing

The low-displacement pendulum is a type of compound pendulum. Accordingly, it swings more slowly than a conventional pendulum of the same length. This can be used to advantage in further reducing air drag, which depends on the velocity of the pendulum. In a simple pendulum, the period is determined by the length because both the inertia and the restoring force scale together with the mass, but in a compound pendulum these two factors need to be controlled independently.

In the low-displacement pendulum the degree of imbalance, which controls the restoring force, can be made arbitrarily small. This allows the period to be increased without changing the length.

For a thin ring, if the distance from the center of rotation to the center of gravity is h, and the radius of the ring is r, then period of the pendulum is:

$$period \approx 2 π \sqrt{\frac{{r}^{2}}{gh}} \qquad ( 1 )$$

where g is the acceleration due to gravity, or expressed in terms of angular frequency:

$$ω \approx \sqrt{\frac{gh}{{r}^{2}}} \qquad ( 2 )$$

Skin drag on an oscillating ring is proportional to area of the surface, the velocity, and to the square root of the viscosity and density of the medium and the frequency of the oscillation. The drag on a low-displacement pendulum of radius r, half-angle φ, and angular frequency ω is:

$$drag = \frac{area r φω \sqrt{μρω}}{\sqrt{2}} \qquad ( 3 )$$

where μ is the viscosity and ρ is the density of the medium, in this case air. Note that benefits to reducing the frequency of oscillation are better than linear. This means that the quality factor Q of the oscillator actually increases as the pendulum is made slower. This may seem counterintuitive because Q is sometimes expressed as frequency divided by damping factor, but in this case the damping factor goes down faster than the frequency. For a low-displacement pendulum:

$$Q = \sqrt{2} \frac{mass ω}{area \sqrt{μρω}} \qquad ( 4 )$$

The above calculations neglect the drag due to the spokes, but they are small and streamlined, and are small compared to the drag of the ring.

There are also additional advantages of having the pendulum swing more slowly. One is that the gear train is simplified because there is less reduction required. Another is that less energy is required to keep the pendulum swinging. The impulse variability per unit time can be reduced if the impulses are delivered less often.

### Temperature Compensation

If the pendulum undergoes thermal expansion, the period changes as specified by formula (I) above. Changes in both r and h effect the period, but these two effects work in opposite directions. The period changes in proportion to r and in inverse proposition to the square root of h. This is because the increase in r increases the inertia of the pendulum, whereas increasing h increases the restoring force. If suitable materials are chosen for the spoke and the ring, the two effects can be made to cancel.

To achieve first-order temperature compensation in a single-spoke-system with a downward spoke, in tension, the coefficient of thermal expansion of the spoke must be slightly greater than that of the ring. Specifically,

$${β}_{down - spoke} = {β}_{ring} ( 1 + \frac{h}{r} ) \qquad ( 5 )$$

This can be achieved by making a portion of the spoke out of material having a higher coefficient of expansion than the material of the ring. For example, if the ring is made of nickel or monel it may be sufficient to make the suspension spring out of stainless steel or phosphor bronze, and the rest of the spoke from the same material as the ring. The exact proportion of spoke length that is made of the high-expansion material is determined by ratio of h to r.

In the case of an upward pointing spoke, the coefficient of thermal expansion of the spoke must be slightly lower than that of the ring. Specifically,

$${β}_{up - spoke} = {β}_{ring} ( 1 - \frac{h}{r} ) \qquad ( 6 )$$

This can be achieved by making a portion of the spoke out of material having a lower coefficient of expansion, for example quartz.

### PRESENTLY PREFERRED EMBODIMENTS

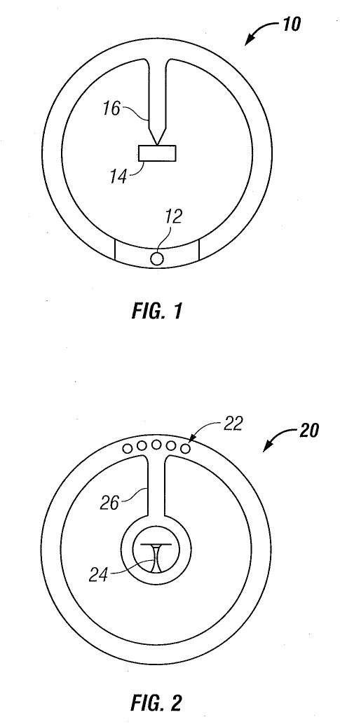

FIG. 1 is a side view showing a spoke up configuration 16 of a low displacement pendulum having a knife edge bearing 14, where a portion 12 of the pendulum ring 10 is made of a higher density material.

FIG. 2 is a side view showing a spoke up configuration 26 of a low displacement pendulum having a suspension spring 24, where voids 22 are formed in the pendulum ring 20 to create imbalance.

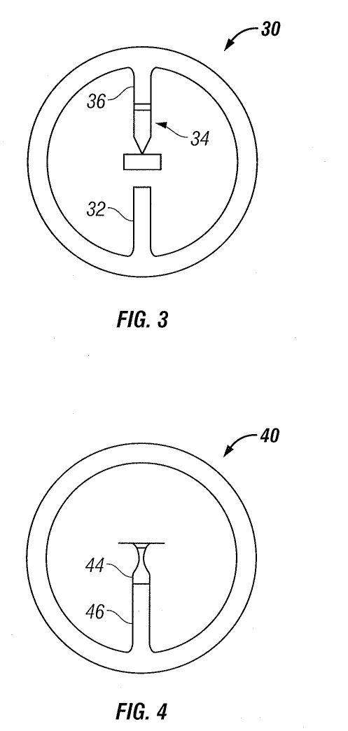

FIG. 3 is a side view showing a spoke up configuration of a low displacement pendulum having upward compensation, where a portion 34 of the pendulum spoke 36 is made of a lower expansion material, and where an optional false spoke 32 is provided to preserve symmetry of the pendulum ring 30.

FIG. 4 is a side view showing a spoke down configuration of a low displacement pendulum having a suspension spring 44, where a pendulum spoke 46 provides weight to create pendulum imbalance in the ring 40.

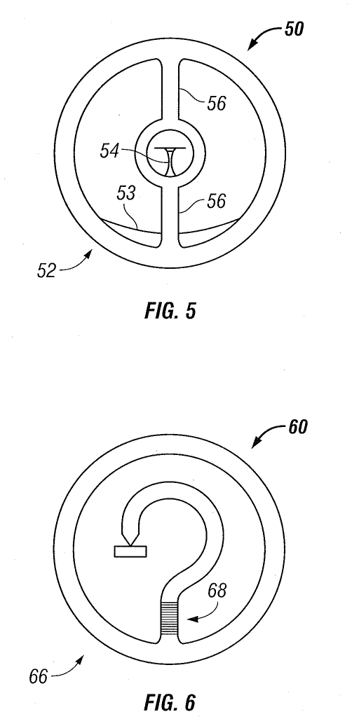

FIG. 5 is a side view showing a symmetrical spoke configuration 56 of a low displacement pendulum having a knife edge bearing 54, where a lower portion 53 of the pendulum ring 52 is thinner to create imbalance in the ring 50.

FIG. 6 is a side view showing a curved spoke configuration of a low displacement pendulum having downward compensation 66 in the ring 60.

### CONCLUSION

The reduction of frictional and barometric errors, combined with simple thermal compensation, make the low-displacement pendulum an alternative to the conventional bob pendulum operated in air. The reduced power requirements and high Q suggest that the slower low-displacement pendulum has greater stability than a conventional pendulum. Whether or not it is more accurate, the reduced input power, reduced wear and simplification of the gear train associated with a longer period, make this an attractive pendulum. The inventors initial experiments look promising. An 18-inch test pendulum, having periods of about three seconds, has a Q of several thousand, which compares favorably with conventional pendulums of the same size and weight.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method of timekeeping, comprising the operations of:
providing a wheel that is unbalanced as to weight in substantially opposing radial directions;
suspending the wheel from a center of rotation, where said wheel is free to rotate about the center of rotation at a site of said suspension that is fixed relative to the Earth;
using said wheel as a gravity pendulum to establish a period for measuring passage of time by swinging said wheel about its center under the effects of gravity and the wheel's own momentum with a heavier portion of the wheel swinging back and forth beneath the wheel's center of rotation; and
minimizing atmospheric displacement resulting from rotation of the wheel by further providing said wheel in a substantially symmetrical shape that does not displace air as said wheel swings back and forth beneath said wheel's center of rotation.

2. The method of claim 1, where the providing operation is performed such that the opposing radial directions comprise first and second directions, and said wheel is fabricated to have an increased amount or density of material in the first direction, and a reduced amount or density of material in the second direction.

3. The method of claim 1, where the providing operation is performed such that wheel comprises a full disk having a thin center, said disk having most of its mass in a thin ring around an edge thereof, wherein inertia per weight is increased at said edge, and wherein mass further from said center contributes most to inertia of said wheel.

4. The method of claim 1, where the providing operation is performed such that the wheel comprises an outer ring coupled via at least one spoke to an attachment at the center of rotation, wherein the outer ring is substantially symmetrical in shape exclusive of said spoke.

5. The method of claim 4, where the providing operation is performed such that said at least one spoke comprises an aerodynamically streamlined shape.

6. The method of claim 4, where the providing operation is performed such that said wheel comprises an outer ring coupled to an attachment at the center of rotation by a single spoke.

7. The method of claim 1, where the providing operation is performed such that the opposing radial directions include first and second directions, wherein said wheel is fabricated to have an increased amount or density of material in the first direction and a reduced amount or density of material in the second direction, and wherein the wheel comprises an outer ring coupled to an attachment at the center of rotation by at least one spoke.

8. The method of claim 7, wherein the providing operation is performed such that the outer ring, exclusive of said spoke, is substantially symmetrical in shape, wherein said spoke extends from the attachment in the first direction, and wherein said attachment comprises a flexure bearing or a suspension spring connected to a distal end of the spoke.

9. The method of claim 7, where the providing operation is performed such that said spoke extends from the attachment in the second direction, and wherein said attachment comprises an inner ring connected to a distal end of said at least one spoke, an inner ring housing comprising one of the following:
a flexure bearing mounted to a portion of the inner ring oriented toward the second direction; and
a suspension spring mounted to a portion of the inner ring oriented toward the second direction.

10. The method of claim 7, wherein the providing operation is performed such that said spoke extends from the attachment in the first direction, and wherein said attachment comprises a knife edge suspension at a distal end of said at least one spoke.

11. The method of claim 7, wherein the providing operation is performed such that said spoke extends from the attachment in the second direction, and wherein said attachment comprises an inner ring housing a knife edge bearing mounted to a portion of the inner ring that is oriented toward the first direction.

12. The method of claim 7, wherein the providing operation is performed such that said spoke extends from the attachment in the first direction, and wherein material from which at least a portion of said spoke is fabricated exhibits a coefficient of thermal expansion greater than that from which the outer ring is fabricated.

13. The method of claim 7, wherein the providing operation is performed such that said spoke extends from the attachment in the second direction, and wherein material from which at least a portion of said spoke is fabricated exhibits a coefficient of thermal expansion that is less than that from which the outer ring is fabricated.

14. The method of claim 9, wherein the providing operation is performed such that said inner ring houses said suspension spring, wherein outer ring is made of either nickel or MONEL, an wherein said suspension spring is made of either stainless steel or phosphor bronze.

15. The method of claim 14, wherein the providing operation is performed such that at least a portion of said spoke is made of quartz.

16. The method of claim 7, wherein the providing operation is performed such that said spoke extends from the attachment in the second direction, and wherein said spoke is curved so that a distal end thereof at the attachment points in the first direction, wherein the distal end comprises one of the following:
a flexure bearing mounted to a portion of the inner ring oriented toward the second direction; and
a suspension spring mounted to a portion of the inner ring oriented toward the second direction.

17. The method of claim 7, wherein the providing operation is performed such that said spoke extends from the attachment in the first direction, and wherein said spoke is curved so that a distal end thereof at the attachment points in the second direction, wherein the distal end comprises a knife edge bearing.

18. The method of claim 1, wherein the providing operation is performed such that the wheel is radially unbalanced as to weight by defining a plurality of voids therein.

19. The method of claim 6, wherein the providing operation is performed such that the wheel comprises a false spoke opposite a single spoke to preserve shape symmetry, wherein the false spoke extends between the outer ring and the attachment but stops short of the attachment.

20. A clock timing method, comprising the steps of:
regulating timing of a mechanical clock using a gravity pendulum provided with a prescribed structure;
wherein said prescribed structure comprises a wheel that is fabricated to be substantially symmetrical in shape, said wheel being radially unbalanced as to weight in substantially opposing radial directions, and wherein the prescribed structure further comprises a suspension site from which the pendulum is hung about a center of rotation.

21. The method of claim 20, further comprising the step of using a suspension site that is fixed relative to the Earth, wherein the pendulum oscillates about the center of rotation while suspended from the suspension site.
